(19) United States
(12) Patent Application Publication
(10) Pub. No.: US 2024/0160352 A1
(43) Pub. Date: May 16, 2024

(54) MEMORY CELL FOLDING OPERATIONS USING HOST SYSTEM MEMORY

(71) Applicant: Micron Technology, Inc., Boise, ID (US)

(72) Inventors: Ritesh Tiwari, Bangalore (IN); Sridhar Prudviraj Gunda, Bangalore (IN); Jameer Mulani, Bangalore (IN)

(21) Appl. No.: 18/506,874

(22) Filed: Nov. 10, 2023

Related U.S. Application Data
(60) Provisional application No. 63/425,922, filed on Nov. 16, 2022.

(51) Int. Cl. G06F 3/06; G06F 12/1009

(52) U.S. Cl. CPC G06F 3/0611; G06F 3/0647; G06F 3/0679; G06F 12/1009

(57) ABSTRACT

Methods, systems, and devices for memory cell folding operations using host system memory are described. A memory system may temporarily store data to host system memory as part of a data transfer operation. For example, the memory system may transfer respective portions of data from a first non-volatile memory device to a first volatile memory device of the memory system and transfer the respective portions of data to a second volatile memory device of the host system based on a storage capacity of the first volatile memory device. The second volatile memory device may accumulate the portions of data until an aggregate size of the data satisfies a threshold, and the host system may transmit the aggregate data to be written to a second non-volatile memory device of the memory system.

### CROSS REFERENCE

The present application for patent claims the benefit of U.S. Provisional Patent Application No. 63/425,922 by TIWARI et al., entitled “MEMORY CELL FOLDING OPERATIONS USING HOST SYSTEM MEMORY,” filed Nov. 16, 2022, assigned to the assignee hereof, and expressly incorporated by reference herein.

### FIELD OF TECHNOLOGY

The following relates to one or more systems for memory, including memory cell folding operations using host system memory.

### BACKGROUND

Memory devices are widely used to store information in various electronic devices such as computers, user devices, wireless communication devices, cameras, digital displays, and the like. Information is stored by programming memory cells within a memory device to various states. For example, binary memory cells may be programmed to one of two supported states, often corresponding to a logic 1 or a logic 0. In some examples, a single memory cell may support more than two possible states, any one of which may be stored by the memory cell. To access information stored by a memory device, a component may read (e.g., sense, detect, retrieve, identify, determine, evaluate) the state of one or more memory cells within the memory device. To store information, a component may write (e.g., program, set, assign) one or more memory cells within the memory device to corresponding states.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), 3-dimensional cross-point memory (3D cross point), not-or (NOR) and not-and (NAND) memory devices, and others. Memory devices may be described in terms of volatile configurations or non-volatile configurations. Volatile memory cells (e.g., DRAM) may lose their programmed states over time unless they are periodically refreshed by an external power source. Non-volatile memory cells (e.g., NAND) may maintain their programmed states for extended periods of time even in the absence of an external power source.

### BRIEF DESCRIPTION OF THE DRAWINGS

FIG. 1 illustrates an example of a system that supports memory cell folding operations using host system memory in accordance with examples as disclosed herein.

FIG. 2 illustrates an example of a system that supports memory cell folding operations using host system memory in accordance with examples as disclosed herein.

FIG. 3 illustrates an example of a system that supports memory cell folding operations using host system memory in accordance with examples as disclosed herein.

FIG. 4 illustrates an example of a flowchart that supports memory cell folding operations using host system memory in accordance with examples as disclosed herein.

FIG. 5 shows a block diagram of a memory system that supports memory cell folding operations using host system memory in accordance with examples as disclosed herein.

FIG. 6 shows a flowchart illustrating a method or methods that support memory cell folding operations using host system memory in accordance with examples as disclosed herein.

### DETAILED DESCRIPTION

Memory systems may support storing information in memory devices including memory cells capable of storing various quantities of bits of information (e.g., 1 or multiple bits of information). In some examples, a memory system may perform folding operations (e.g., garbage collect operations), to transfer (e.g., collect, aggregate, accumulate) data to be stored in multiple-level memory cells (e.g., memory cells configured to store multiple bits of information). For example, accessing memory cells configured to store relatively fewer bits of information may be faster than accessing memory cells configured to store relatively more bits of information. The memory system may transfer information stored to a first non-volatile memory device (e.g., a first set of memory cells) associated with a first access latency to a second non-volatile memory device (e.g., a second set of memory cells) associated with a second access latency greater than the first access latency, for example, to free up storage space of the first non-volatile memory device.

The memory system may facilitate such transfers via a volatile memory device. For example, the memory system may read data from the first non-volatile memory device to the volatile memory device and may write the data from the volatile memory device to the second non-volatile memory device. In some examples, the memory system may perform a multi-stage (e.g., two-stage) write operation to write data to the second non-volatile memory device. As such, data read to the volatile memory device may remain stored in the volatile memory device until after a final stage of the write operation is completed. However, a capacity of the volatile memory device (e.g., a portion of the volatile memory device allocated for data transfers) may be limited such that it may be prohibitive to store an entirety of the data (e.g., or even subsets of the data) to be transferred to the second non-volatile memory device for an extended duration of time. Here, the memory system may temporarily store portions of the data in a set of non-volatile memory cells (e.g., a set of not-and (NAND) cells), which may be subsequently read by the volatile memory device as part of respective stages of the write operation. However, accessing non-volatile memory cells may be slower than accessing volatile memory cells. Accordingly, temporarily storing data to the set of non-volatile memory cells may increase a latency of folding (e.g., transferring) the data to the second non-volatile memory device, but additional capacity of the volatile memory device to avoid such temporary storage may be unavailable.

In accordance with examples as disclosed herein, the memory system may be configured to support folding operations in which data to be transferred from the first non-volatile memory device to the second non-volatile memory device may be temporarily stored to a volatile memory device of a host system. That is, while the capacity of the volatile memory device of the memory system may remain limited, volatile memory of the host system may be used to temporarily store the data instead of non-volatile memory of the memory system, thereby reducing latency of the folding operation, among other benefits. For example, accessing the volatile memory device of the host system may take less time than accessing a set of non-volatile memory cells that temporarily stores the data. The memory system may transfer respective portions of the data from the first non-volatile memory device to a first volatile memory device of the memory system and transfer the respective portions of data to a second volatile memory device of the host system. The second volatile memory device may accumulate the portions of data until an aggregate size of the data satisfies a threshold (e.g., a quantity of data that may be stored by a pageline of the second non-volatile memory device), and the first volatile memory device may read the aggregate data (e.g., in respective portions) for writing to the second non-volatile memory device as part of a first stage. The second volatile memory device may continue to store the data while additional data to be transferred to the second non-volatile memory device is aggregated at the second volatile memory device. The first volatile memory device may subsequently read the aggregate data from the second volatile memory device for writing to the second non-volatile memory device as part of a second stage based on which the data may be written to the second non-volatile memory device. Thus, such techniques may reduce a quantity of access operations (e.g., read operations, write operations) included in a folding operation that are associated with non-volatile memory cells (e.g., NAND memory cells), for example, by performing such access operations using volatile memory cells of the host system. As such, latency of the folding operation is reduced and a duration of non-volatile memory engagement is reduced, among other benefits.

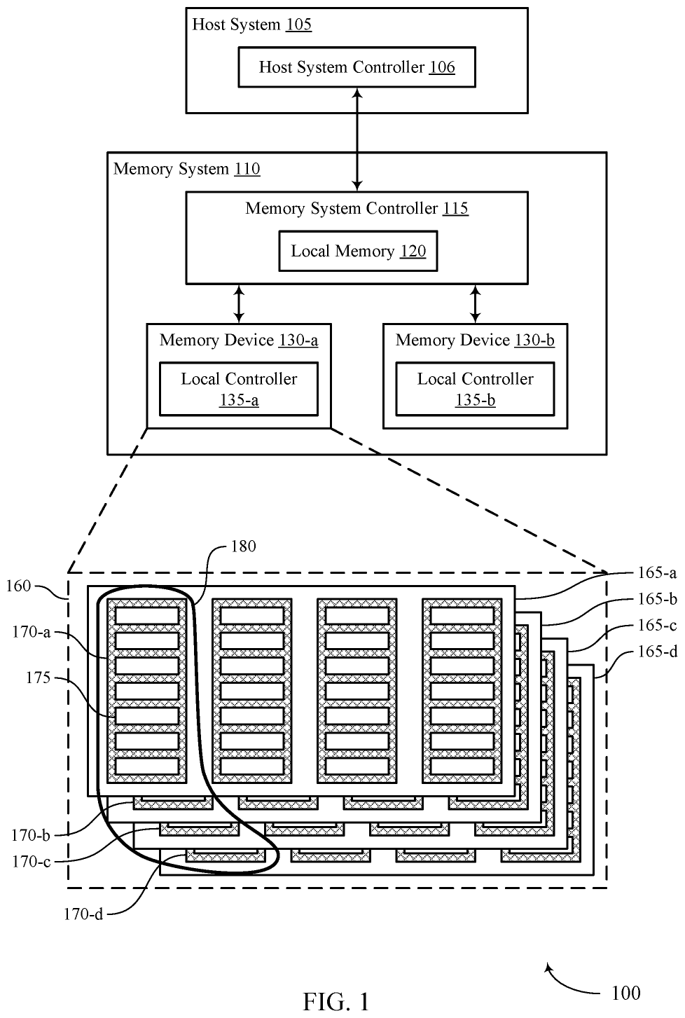

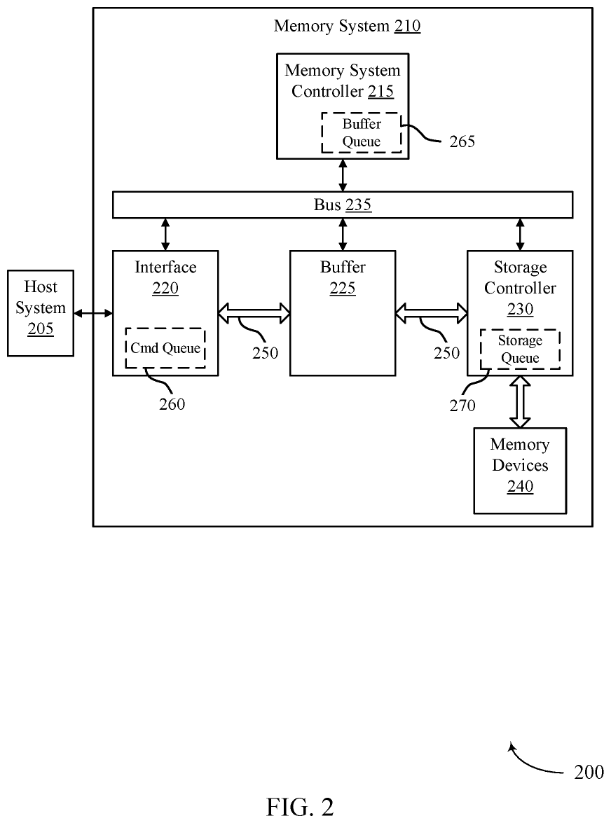

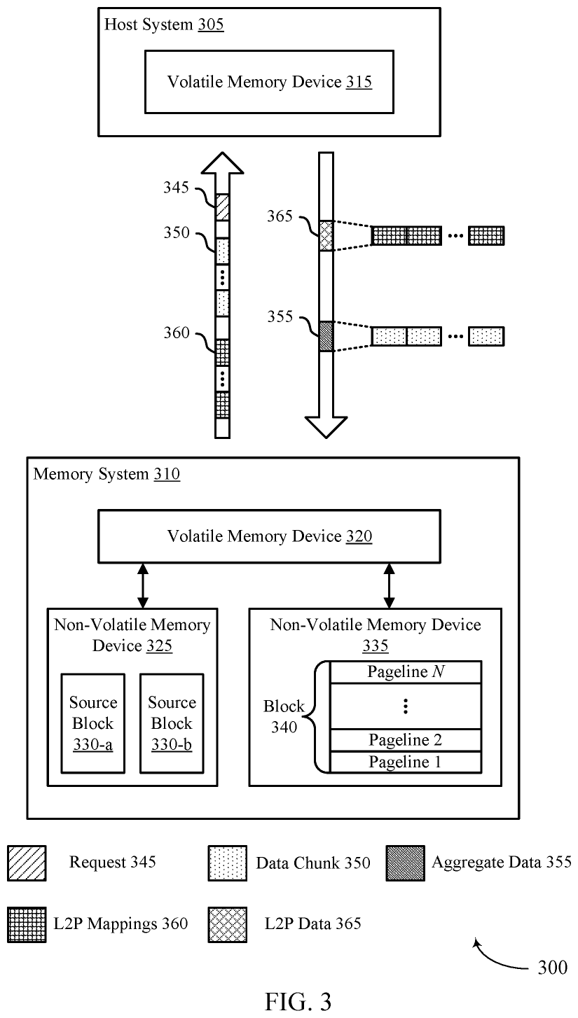

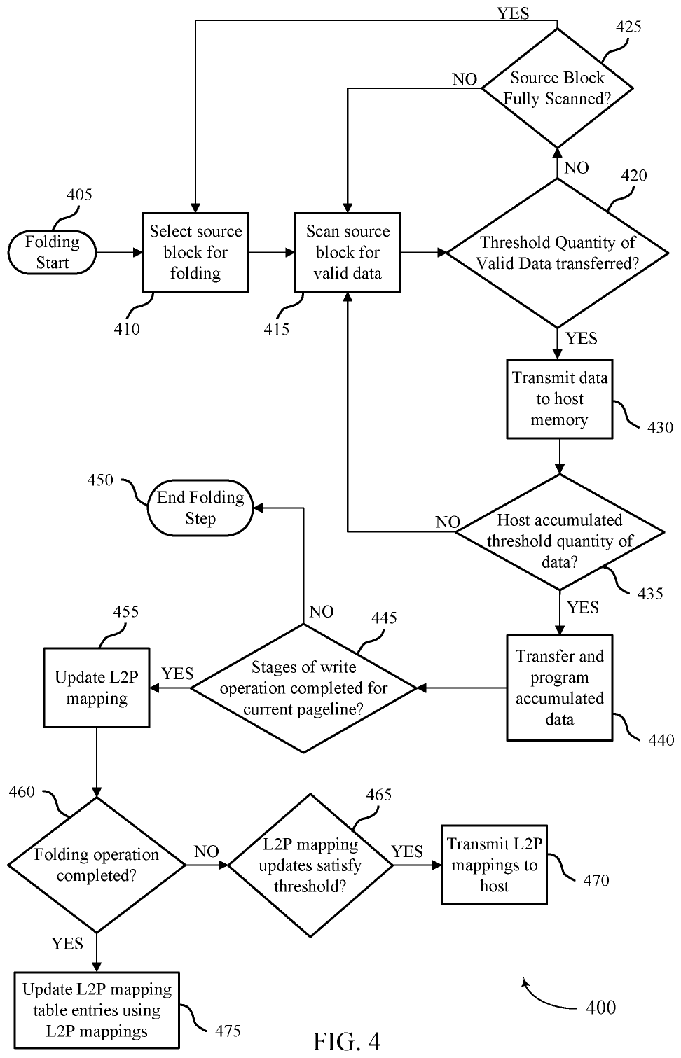

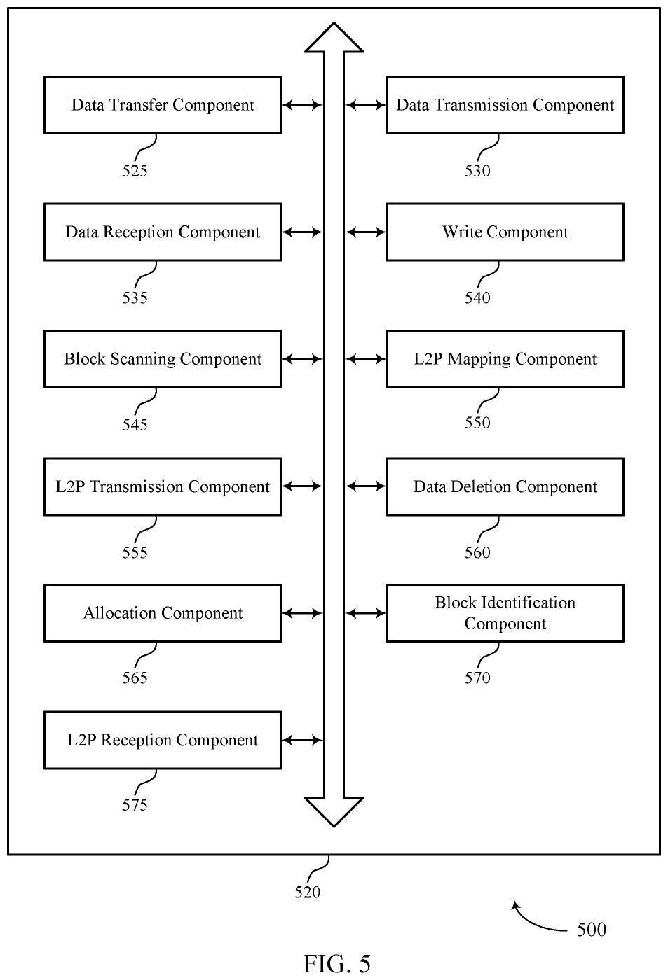

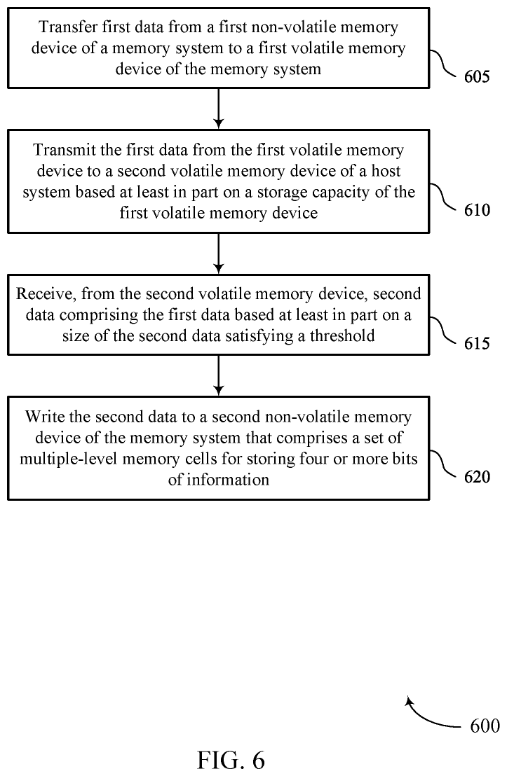

Features of the disclosure are initially described in the context of systems, devices, and circuits with reference to FIGS. 1 through 2. Features of the disclosure are described in the context of systems and flowcharts with reference to FIGS. 3 through 4. These and other features of the disclosure are further illustrated by and described in the context of an apparatus diagram and flowchart that relate to memory cell folding operations using host system memory with reference to FIGS. 5 through 6.

FIG. 1 illustrates an example of a system 100 that supports memory cell folding operations using host system memory in accordance with examples as disclosed herein. The system 100 includes a host system 105 coupled with a memory system 110.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other possibilities.

The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller, UFS host controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (RAM) (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170, and in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

In some examples, a pageline may refer to a single row of pages 175 of a virtual block 180. For example, a pageline corresponding to a first row of a virtual block 180 may include the first page 175 of each block 170 of a group of blocks 170 included in the virtual block 180.

For some NAND architectures, memory cells may be read and programmed (e.g., written) at a first level of granularity (e.g., at the page level of granularity) but may be erased at a second level of granularity (e.g., at the block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained, and data may be marked as valid or invalid at the page level of granularity, and a page 175 may contain valid data, invalid data, or no data. Invalid data may be data that is outdated due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

The system 100 may include any quantity of non-transitory computer readable media that support memory cell folding operations using host system memory. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In some examples, the memory system 110 may support folding operations in which valid data stored to a first memory device (e.g., the memory device 130-a, a first set of memory cells) may be aggregated (e.g., collected, accumulated, read) and transferred to a second memory device (e.g., the memory device 130-b, a second set of memory cells). For example, the memory system 110 may transfer data stored at the memory device 130-a to the second memory device 130-b, which may be examples of non-volatile memory devices. In some cases, a folding operation may include changing a density of the information being stored—e.g., from a first density (such as three-bits per memory cell) to a second density (such as four-bits per memory cell). In some examples, the memory system may facilitate such transfers via a volatile memory device (e.g., the memory system controller 115, the local memory 120). For example, the volatile memory device may scan the memory device 130-a for valid data and read the valid data from the memory device 130-a, for example, until a quantity of the valid data satisfies a storage capacity of the volatile memory device (e.g., a portion of the volatile memory device allocated for data transfers). Based on the storage capacity being satisfied, the memory system 110 may temporarily store the valid data in a set of non-volatile memory cells (e.g., of the memory device 130-a, 103-b, or another memory device 130, a set of NAND latches) such that additional valid data of the memory device 130-a may be accumulated and stored at the set of non-volatile memory cells via the volatile memory device.

In some examples, valid data may be accumulated at the set of non-volatile memory cells until a size (e.g., quantity) of the accumulated data satisfies a threshold, such as a quantity of data stored by a pageline of the memory device 130-b. The volatile memory device may then read the data from the set of non-volatile memory cells for writing to the memory device 130-b as part of a first stage of a write operation. Additional valid data for transfer to the memory device 130-b may be accumulated at the set of non-volatile memory cells and then written to the memory device 130-b via the volatile memory device as part of a first stage. The volatile memory device may subsequently retrieve the accumulated data again from the set of non-volatile memory cells for writing to the memory device 130-b as part of a second stage of the write operation based on which the data may be written to the memory device 130-b. However, a latency of transferring data between memory devices 130 may be associated with (e.g., limited by) a latency of temporarily accumulating data at and accessing the set of non-volatile memory cells (e.g., corresponding to a relatively slow access time compared to accessing volatile memory cells).

In accordance with examples as disclosed herein, the memory system 110 (e.g., via the memory system controller 115) may be configured to support a folding operation in which valid data transferred between memory devices 130 (e.g., between blocks 170 of a same memory device 130) may be temporarily stored to a volatile memory device of the host system 105 (e.g., included in the host system controller 106). For example, instead of temporarily accumulating and storing valid data to non-volatile memory cells as part of the folding operation, the memory system 110 may temporarily accumulate and store the valid data to the volatile memory device of the host system 105, which will reduce folding operation latency and reduce non-volatile memory cell accesses and engagement, among other benefits.

FIG. 2 illustrates an example of a system 200 that supports memory cell folding operations using host system memory in accordance with examples as disclosed herein. The system 200 may be an example of a system 100 as described with reference to FIG. 1, or aspects thereof. The system 200 may include a memory system 210 configured to store data received from the host system 205 and to send data to the host system 205, if requested by the host system 205 using access commands (e.g., read commands or write commands). The system 200 may implement aspects of the system 100 as described with reference to FIG. 1. For example, the memory system 210 and the host system 205 may be examples of the memory system 110 and the host system 105, respectively.

The memory system 210 may include one or more memory devices 240 to store data transferred between the memory system 210 and the host system 205 (e.g., in response to receiving access commands from the host system 205). The memory devices 240 may include one or more memory devices as described with reference to FIG. 1. For example, the memory devices 240 may include NAND memory, PCM, self-selecting memory, 3D cross point or other chalcogenide-based memories, FERAM, MRAM, NOR (e.g., NOR flash) memory, STT-MRAM, CBRAM, RRAM, or OxRAM, among other examples.

The memory system 210 may include a storage controller 230 for controlling the passing of data directly to and from the memory devices 240 (e.g., for storing data, for retrieving data, for determining memory locations in which to store data and from which to retrieve data). The storage controller 230 may communicate with memory devices 240 directly or via a bus (not shown), which may include using a protocol specific to each type of memory device 240. In some cases, a single storage controller 230 may be used to control multiple memory devices 240 of the same or different types. In some cases, the memory system 210 may include multiple storage controllers 230 (e.g., a different storage controller 230 for each type of memory device 240). In some cases, a storage controller 230 may implement aspects of a local controller 135 as described with reference to FIG. 1.

The memory system 210 may include an interface 220 for communication with the host system 205, and a buffer 225 for temporary storage of data being transferred between the host system 205 and the memory devices 240. The interface 220, buffer 225, and storage controller 230 may support translating data between the host system 205 and the memory devices 240 (e.g., as shown by a data path 250), and may be collectively referred to as data path components.

Using the buffer 225 to temporarily store data during transfers may allow data to be buffered while commands are being processed, which may reduce latency between commands and may support arbitrary data sizes associated with commands. This may also allow bursts of commands to be handled, and the buffered data may be stored, or transmitted, or both (e.g., after a burst has stopped). The buffer 225 may include relatively fast memory (e.g., some types of volatile memory, such as SRAM or DRAM), or hardware accelerators, or both to allow fast storage and retrieval of data to and from the buffer 225. The buffer 225 may include data path switching components for bi-directional data transfer between the buffer 225 and other components.

A temporary storage of data within a buffer 225 may refer to the storage of data in the buffer 225 during the execution of access commands. For example, after completion of an access command, the associated data may no longer be maintained in the buffer 225 (e.g., may be overwritten with data for additional access commands). In some examples, the buffer 225 may be a non-cache buffer. For example, data may not be read directly from the buffer 225 by the host system 205. In some examples, read commands may be added to a queue without an operation to match the address to addresses already in the buffer 225 (e.g., without a cache address match or lookup operation).

The memory system 210 also may include a memory system controller 215 for executing the commands received from the host system 205, which may include controlling the data path components for the moving of the data. The memory system controller 215 may be an example of the memory system controller 115 as described with reference to FIG. 1. A bus 235 may be used to communicate between the system components.

In some cases, one or more queues (e.g., a command queue 260, a buffer queue 265, a storage queue 270) may be used to control the processing of access commands and the movement of corresponding data. This may be beneficial, for example, if more than one access command from the host system 205 is processed concurrently by the memory system 210. The command queue 260, buffer queue 265, and storage queue 270 are depicted at the interface 220, memory system controller 215, and storage controller 230, respectively, as examples of a possible implementation. However, queues, if implemented, may be positioned anywhere within the memory system 210.

Data transferred between the host system 205 and the memory devices 240 may be conveyed along a different path in the memory system 210 than non-data information (e.g., commands, status information). For example, the system components in the memory system 210 may communicate with each other using a bus 235, while the data may use the data path 250 through the data path components instead of the bus 235. The memory system controller 215 may control how and if data is transferred between the host system 205 and the memory devices 240 by communicating with the data path components over the bus 235 (e.g., using a protocol specific to the memory system 210).

If a host system 205 transmits access commands to the memory system 210, the commands may be received by the interface 220 (e.g., according to a protocol, such as a UFS protocol or an eMMC protocol). Thus, the interface 220 may be considered a front end of the memory system 210. After receipt of each access command, the interface 220 may communicate the command to the memory system controller 215 (e.g., via the bus 235). In some cases, each command may be added to a command queue 260 by the interface 220 to communicate the command to the memory system controller 215.

The memory system controller 215 may determine that an access command has been received based on the communication from the interface 220. In some cases, the memory system controller 215 may determine the access command has been received by retrieving the command from the command queue 260. The command may be removed from the command queue 260 after it has been retrieved (e.g., by the memory system controller 215). In some cases, the memory system controller 215 may cause the interface 220 (e.g., via the bus 235) to remove the command from the command queue 260.

After a determination that an access command has been received, the memory system controller 215 may execute the access command. For a read command, this may include obtaining data from one or more memory devices 240 and transmitting the data to the host system 205. For a write command, this may include receiving data from the host system 205 and moving the data to one or more memory devices 240. In either case, the memory system controller 215 may use the buffer 225 for, among other things, temporary storage of the data being received from or sent to the host system 205. The buffer 225 may be considered a middle end of the memory system 210. In some cases, buffer address management (e.g., pointers to address locations in the buffer 225) may be performed by hardware (e.g., dedicated circuits) in the interface 220, buffer 225, or storage controller 230.

To process a write command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the write command.

In some cases, a buffer queue 265 may be used to control a flow of commands associated with data stored in the buffer 225, including write commands. The buffer queue 265 may include the access commands associated with data currently stored in the buffer 225. In some cases, the commands in the command queue 260 may be moved to the buffer queue 265 by the memory system controller 215 and may remain in the buffer queue 265 while the associated data is stored in the buffer 225. In some cases, each command in the buffer queue 265 may be associated with an address at the buffer 225. For example, pointers may be maintained that indicate where in the buffer 225 the data associated with each command is stored. Using the buffer queue 265, multiple access commands may be received sequentially from the host system 205 and at least portions of the access commands may be processed concurrently.

If the buffer 225 has sufficient space to store the write data, the memory system controller 215 may cause the interface 220 to transmit an indication of availability to the host system 205 (e.g., a “ready to transfer” indication), which may be performed in accordance with a protocol (e.g., a UFS protocol, an eMMC protocol). As the interface 220 receives the data associated with the write command from the host system 205, the interface 220 may transfer the data to the buffer 225 for temporary storage using the data path 250. In some cases, the interface 220 may obtain (e.g., from the buffer 225, from the buffer queue 265) the location within the buffer 225 to store the data. The interface 220 may indicate to the memory system controller 215 (e.g., via the bus 235) if the data transfer to the buffer 225 has been completed.

After the write data has been stored in the buffer 225 by the interface 220, the data may be transferred out of the buffer 225 and stored in a memory device 240, which may involve operations of the storage controller 230. For example, the memory system controller 215 may cause the storage controller 230 to retrieve the data from the buffer 225 using the data path 250 and transfer the data to a memory device 240. The storage controller 230 may be considered a back end of the memory system 210. The storage controller 230 may indicate to the memory system controller 215 (e.g., via the bus 235) that the data transfer to one or more memory devices 240 has been completed.

In some cases, a storage queue 270 may support a transfer of write data. For example, the memory system controller 215 may push (e.g., via the bus 235) write commands from the buffer queue 265 to the storage queue 270 for processing. The storage queue 270 may include entries for each access command. In some examples, the storage queue 270 may additionally include a buffer pointer (e.g., an address) that may indicate where in the buffer 225 the data associated with the command is stored and a storage pointer (e.g., an address) that may indicate the location in the memory devices 240 associated with the data. In some cases, the storage controller 230 may obtain (e.g., from the buffer 225, from the buffer queue 265, from the storage queue 270) the location within the buffer 225 from which to obtain the data. The storage controller 230 may manage the locations within the memory devices 240 to store the data (e.g., performing wear-leveling, performing garbage collection). The entries may be added to the storage queue 270 (e.g., by the memory system controller 215). The entries may be removed from the storage queue 270 (e.g., by the storage controller 230, by the memory system controller 215) after completion of the transfer of the data.

To process a read command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the read command.

In some cases, the buffer queue 265 may support buffer storage of data associated with read commands in a similar manner as discussed with respect to write commands. For example, if the buffer 225 has sufficient space to store the read data, the memory system controller 215 may cause the storage controller 230 to retrieve the data associated with the read command from a memory device 240 and store the data in the buffer 225 for temporary storage using the data path 250. The storage controller 230 may indicate to the memory system controller 215 (e.g., via the bus 235) when the data transfer to the buffer 225 has been completed.

In some cases, the storage queue 270 may be used to aid with the transfer of read data. For example, the memory system controller 215 may push the read command to the storage queue 270 for processing. In some cases, the storage controller 230 may obtain (e.g., from the buffer 225, from the storage queue 270) the location within one or more memory devices 240 from which to retrieve the data. In some cases, the storage controller 230 may obtain (e.g., from the buffer queue 265) the location within the buffer 225 to store the data. In some cases, the storage controller 230 may obtain (e.g., from the storage queue 270) the location within the buffer 225 to store the data. In some cases, the memory system controller 215 may move the command processed by the storage queue 270 back to the command queue 260.

Once the data has been stored in the buffer 225 by the storage controller 230, the data may be transferred from the buffer 225 and sent to the host system 205. For example, the memory system controller 215 may cause the interface 220 to retrieve the data from the buffer 225 using the data path 250 and transmit the data to the host system 205 (e.g., according to a protocol, such as a UFS protocol or an eMMC protocol). For example, the interface 220 may process the command from the command queue 260 and may indicate to the memory system controller 215 (e.g., via the bus 235) that the data transmission to the host system 205 has been completed.

The memory system controller 215 may execute received commands according to an order (e.g., a first-in-first-out order, according to the order of the command queue 260). For each command, the memory system controller 215 may cause data corresponding to the command to be moved into and out of the buffer 225, as discussed herein. As the data is moved into and stored within the buffer 225, the command may remain in the buffer queue 265. A command may be removed from the buffer queue 265 (e.g., by the memory system controller 215) if the processing of the command has been completed (e.g., if data corresponding to the access command has been transferred out of the buffer 225). If a command is removed from the buffer queue 265, the address previously storing the data associated with that command may be available to store data associated with a new command.

In some examples, the memory system controller 215 may be configured for operations associated with one or more memory devices 240. For example, the memory system controller 215 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., LBAs) associated with commands from the host system 205 and physical addresses (e.g., physical block addresses) associated with memory cells within the memory devices 240. For example, the host system 205 may issue commands indicating one or more LBAs and the memory system controller 215 may identify one or more physical block addresses indicated by the LBAs. In some cases, one or more contiguous LBAs may correspond to noncontiguous physical block addresses. In some cases, the storage controller 230 may be configured to perform one or more of the described operations in conjunction with or instead of the memory system controller 215. In some cases, the memory system controller 215 may perform the functions of the storage controller 230 and the storage controller 230 may be omitted.

In some examples, the memory system 210 may use buffer 225 to facilitate data transfers between memory devices 240 (e.g., folding operations). For example, data transferred from a first memory device 240 to a second memory device 240 (e.g., from a first set of memory cells of the first memory device 240 to a second set of memory cells of the first memory device 240) may be transferred via the buffer 225. In some cases, a storage capacity of the buffer 225 allocated for such data transfers may be relatively limited such that the transferred data may be temporarily stored elsewhere and subsequently retrieved by the buffer 225 for writing to the second memory device 240. To improve a latency of these data transfers, the buffer 225 may be configured to temporarily store the data to a volatile memory device of the host system 205 (e.g., instead of non-volatile memory of the memory system 210). For example, a latency of storing data to and subsequently retrieving data from volatile memory of the host system 205 may be less than a latency of storing the data to and retrieving the data from non-volatile memory of the memory system 210, thereby resulting in reduced latency of the folding operation relative to if the data were temporarily stored to non-volatile memory of the memory system 210.

FIG. 3 illustrates an example of a system 300 that supports memory cell folding operations using host system memory in accordance with examples as disclosed herein. The system 300 may be an example of aspects of the system 100 or the system 200 as described with reference to FIGS. 1 and 2. For example, the system 300 may include a memory system 310, which may be an example of a memory system 110 or 210 described with reference to FIGS. 1 and 2. The memory system 310 may include a volatile memory device 320, which may be an example a memory system controller 115, local memory 120, or a buffer 225 described with reference to FIGS. 1 and 2. The memory system 310 may also include a non-volatile memory device 325 and a non-volatile memory device 335, which may be examples of a memory device 130 or 240, as described with reference to FIGS. 1 and 2. Additionally, the system 300 may include a host system 305, which may be an example of a host system 105 or 205 as described with reference to FIGS. 1 and 2.

In some examples, the memory system 310 may transfer data from a set of memory cells having a first storage density (e.g., an array of SLCs, an array of MLCs array, an array of TLCs) to a set of memory cells having a second storage density that is higher than the first storage density (e.g., a QLC array or an array of memory cells supporting a higher density). That is, the memory system 310 may transfer data from memory cells each configured to store a first quantity of bits to memory cells each configured to store a second quantity of bits that is greater than the first quantity of bits. For example, the non-volatile memory device 325 may be configured to store data in relatively lower density memory cells (e.g., SLCs, MLCs, TLCs), whereas the non-volatile memory device 335 may be configured to store data in relatively higher density memory cells (e.g., QLCs, memory cells configured to store more than 4 bits of data). It is noted that, while the non-volatile memory device 325 and the non-volatile memory device 335 are depicted as being separate memory devices, in some examples, these devices may be included in a same non-volatile memory device (e.g., correspond to different sets of memory cells within a same non-volatile memory device).

To transfer data from the non-volatile memory device 325 to the non-volatile memory device 335, the memory system 310 may read data (e.g., valid data) from a first quantity of memory cells of the non-volatile memory device 325 and may write the data to a second quantity (e.g., a smaller quantity) of memory cells of the non-volatile memory device 335. The data, however, may not be immediately written into the to the non-volatile memory device 335 because of the differences in the storage density of the data. For example, if you read TLC data from the non-volatile memory device 325 and intend to write QLC data into the non-volatile memory device 335, it may take more than one read operation of the non-volatile memory device 325 to accumulate enough data to transfer into the non-volatile memory device 335. By transferring the data from the non-volatile memory device 325 to the non-volatile memory device 335, the memory system may leverage relatively faster access times associated with lower density memory cells as well as relatively higher capacity associated with higher density memory cells. For example, data received from the host system 305 may initially be written to lower density memory cells (e.g., to support faster access operations with the host system 305). The data may be subsequently transferred to higher density memory cells (e.g., as part of a folding operation) to free up storage space of the lower density memory cells and leverage the higher storage capacity of the higher density memory cells.

In some cases, a write operation to write data to higher density memory cells (e.g., QLCs) may include multiple-stages (e.g., multiple programming operations). For example, precision of programming higher density memory cells may be higher than programming lower density memory cells to accommodate narrower read and write margins. To achieve such precision while avoiding memory cell damage associated with longer application of voltages, the memory system 310 may perform multiple (e.g., two) shorter programming operations to write the data (e.g., two stages of the same write operation). Accordingly, to support transferring data from the non-volatile memory device 325 to the non-volatile memory device 335, the memory system 310 may read the data from the non-volatile memory device 325 and program the data to memory cells of the non-volatile memory device 335 via multiple write operation stages (e.g., programming operations). For example, the memory system 310 may perform write operation including a first stage (e.g., a first programming operation, a first voltage pulse) associated with an initial biasing of the memory cells towards a desired logic state (e.g., coarse programming) and a second stage associated with a final biasing of the memory cells to the desired logic state (e.g., fine programming). That is, the data may be written to the memory cells of the non-volatile memory device 335 based on (e.g., in response to, as a result of) to the second stage of the write operation. The second stage may be subsequent to the first stage, and the memory system 310 may perform other operations (e.g., read operations, write operations to other devices, first stages of other write operations to the non-volatile memory device 335) between performing the first stage and the second stage.

To support folding data from the non-volatile memory device 325 to the non-volatile memory device 335, the memory system 310 may temporarily store data read from the non-volatile memory device 325 to a volatile memory device 320 (e.g., an SRAM device, a DRAM device, a buffer, a cache, or the like), which may support relatively faster access operations (e.g., in comparison to a non-volatile memory device, such as a NAND device). For example, the memory system 310 may transfer data from the non-volatile memory device 325 to the non-volatile memory device 335 via the volatile memory device 320. Accordingly, the memory system 310 may allocate a portion of the volatile memory device 320 to be available for data transfers.

In some cases, however, a size of the data transferred as part of a folding operation may exceed a storage capacity of the volatile memory device 320 (e.g., the portion allocated for data transfers). For instance, in an example, the non-volatile memory device 325 may include SLCs and the non-volatile memory device 335 may include QLCs, and each of the memory devices may include 4 dies (e.g., dies 160) with 6 planes per die (e.g., planes 165). In this example, a pageline of the non-volatile memory devices may correspond to 4*6=24 pages (e.g., pages 175). Because each QLC may store 4 times the quantity of bits as those stored by an SLC, the quantity of data stored by a pageline of the non-volatile memory device 335 may equal the data stored by 4 pagelines of the non-volatile memory device 325 (e.g., 4*24=96 pages). Thus, if each page of the non-volatile memory device stored 16 kilobytes (KB) of data, to write a pageline of data to the non-volatile memory device 335, the memory system 310 may accumulate a relatively large amount of data (e.g., 16 KB*96 pages=1536 KB) with respect to the portion of the volatile memory device 320 allocated for data transfers (e.g., 16 KB). For example, some lower-cost SSD controllers or MNAND devices may be configured with limited SRAM to reduce a cost of the devices, and thus the allocated portion of the volatile memory device 320 may be limited relative to the quantity of data transferred as part of folding operation.

Additionally, the memory system 310 may aggregate data for storage to multiple pagelines of the non-volatile memory device 335 while maintaining data associated with a current pageline. For example, if transferring 5 QLC pagelines worth of data to the non-volatile memory device 335, the memory system 310 may perform the first stage of respective write operations for each pageline prior to performing the second stage of the respective write operations for each pageline. Thus, in this example, the memory system 310 may accumulate 1536*5=7680 KB of data to transfer to the non-volatile memory device 335.

To support data accumulation and multi-stage programming in view of limited storage capacity of the volatile memory device 320, the memory system 310 may transfer (e.g., accumulate, collect, aggregate, gather) data from the non-volatile memory device 325 to the volatile memory device 320, for example, until satisfying (e.g., reaching) the allocated storage capacity of the volatile memory device 320. The memory system 310 may then temporarily store the data (e.g., a data chunk) to a set of non-volatile memory cells (e.g., SLC latches, another non-volatile memory device) to free up space at the volatile memory device 320. The memory system 310 may continue to accumulate data for transfer at the set of non-volatile memory cells, which may be subsequently retrieved and written to the non-volatile memory device 335. However, accumulating data to non-volatile memory cells and subsequently transferring the accumulated data to the non-volatile memory device 335 may increase access operations to non-volatile memory cells of the memory system 310, which may be associated with a higher latency relative to accessing volatile memory cells. Additionally, increasing the quantity of access operations to non-volatile memory cells may increase the wear on the non-volatile memory cells, thereby reducing an operational lifetime of the non-volatile memory cells. Further, some operations of the memory system 310 may be delayed until folding to the non-volatile memory device 335 is complete, and thus increasing a latency of folding operations may decrease an overall performance of the memory system 310.

To support improved folding operations, the memory system 310 may utilize a volatile memory device 315 associated with a host system 305 to accumulate and temporarily store data to support programming (e.g., folding) to higher density memory cells (e.g., QLCs). In some examples, the memory system 310 may transmit a request 345 to the host system 305, which may request a portion of the volatile memory device 315 in which the memory system 310 may store data. For example, the request 345 may request that the host system 305 allocate the portion of the volatile memory device 315 to the memory system 310 for storage, and the memory system 310 may use the portion of the volatile memory device 315 to temporarily store data due a folding operation. In some examples, the memory system 310 may transmit the request 345 as part of or in response to a power up procedure (e.g., boot up procedure) of the memory system 310, a power procedure of the host system 305, or both.

As part of a folding operation, the memory system 310 may transfer one or more data chunks 350 to the volatile memory device 315. For example, the memory system 310 may select a source block 330-a (e.g., a block 170, a virtual block 180) and may scan the source block 330-a for valid data. In some such examples, the memory system 310 may transfer the valid data to the volatile memory device 320 until satisfying (e.g., equaling, meeting, reaching) a storage capacity of the volatile memory device 320 (e.g., 16 KB of data, 32 KB of data, 16 KB of data per plane of a memory die, or the like) or some other threshold quantity of valid data. Additionally, or alternatively, the memory system 310 may identify that the source block 330-a has been fully scanned prior to satisfying the storage capacity of the volatile memory device 320, and may select another source block (e.g., a source block 330-b) to scan for valid data. That is, the memory system 310 may read valid data from one or more source blocks 330 of the non-volatile memory device 325 to aggregate the valid data as a data chunk 350 (e.g., corresponding to the storage capacity of the volatile memory device 320 or the threshold quantity of valid data). The memory system 310 may transmit the data chunk 350 to the volatile memory device 315, for example, in response to the data chunk 350 satisfying the storage capacity of the volatile memory device 320. In some examples, such as when aspects of the system 300 implemented by (e.g., included in) a universal flash storage (UFS) device, the volatile memory device 315 may be an example of a unified memory buffer (UMB) or a host performance booster (HPB). In some other examples, such as when aspects of the system 300 are implemented by a non-volatile memory express (NVMe) or a peripheral component interconnect express (PCIe) device, the volatile memory device 315 may be an example of a host memory buffer (HMB).

The volatile memory device 315 of the host system 305 may include a portion of a volatile memory resources configured to support operations of the memory system 310. Many host systems 305 may be coupled with a memory system for storing information long-term (e.g., the memory system 310 that uses NAND cells) and a memory system for storing information for a shorter-term and with quicker access (e.g., volatile memory device 315). The volatile memory device 315 may be controlled by the host system 305. In some cases, however, at least a portion of the volatile memory device 315 may be dedicated for use by operations associated with the memory system 310. The techniques described herein include using the portion of the volatile memory device 315 that is configured to support operations of the memory system to perform folding operations.

In some examples, the memory system 310 may continue to aggregate data chunks 350 at the volatile memory device 320 from the source blocks 330 of the non-volatile memory device 325 and transmit data chunks 350 to the volatile memory device 315 until the volatile memory device 315 has accumulated a threshold size of data. For example, the volatile memory device 320 may aggregate data chunks 350 at the volatile memory device 315 until a size of an aggregate data 355 (e.g., data corresponding to the aggregation of the data chunks 350) corresponds to a size of a pageline of a block 340 (e.g., a QLC block) of the non-volatile memory device 335.

Based on the aggregate data 355 satisfying the threshold size of data, the host system 305 may transmit the aggregate data 355 to the memory system 310 for writing to the non-volatile memory device 335, for example, in respective data chunks 350. For example, the memory system 310 may read the aggregate data 355 in respective data chunks 350 in accordance with the capacity of the volatile memory device 320 and write the respective data chunks 350 to the non-volatile memory device 335 (e.g., a pageline of the non-volatile memory device 335) as part of first stage of a write operation to write the aggregate data 355. For instance, the memory system 310 may perform a first set of programming operations (e.g., coarse programming) for a pageline of the block 340 (e.g., pageline 1) using the aggregate data 355 (e.g., a programming operation per data chunk 350).

After performing the first stage of the write operation, the memory system 310 may similarly aggregate additional data chunks 350 at the volatile memory device 320 and transmit the additional data chunks 350 to the volatile memory device 315, where the additional data chunks 350 may include data for an additional pageline of the block 340 (e.g., pageline 2). Additional aggregate data 355 corresponding to the additional data chunks 350 may satisfy the threshold size of the data, and the memory system 310 may read the additional aggregate data 355 and write the additional aggregate data 355 in respective additional data chunks 350 to the non-volatile memory device 335. Such data aggregation and communication between the memory system 310 may continue for each pageline of the block 340 to which the memory system 310 is to transfer data as part of the folding operation. That is, the memory system 310 and the host system 305 may exchange data (e.g., data chunks 350) such that multiple pagelines of the block 340 (e.g., N pagelines) are programmed as part of a respective first stage (e.g., using a respective aggregate data 355) prior to the memory system 310 performing second stages of the write operations.

The memory system 310 may access respective aggregate data 355 stored at the volatile memory device 315 to perform the second stage of the write operation for each pageline. For example, after completing the first programming pass for each pageline of the block 340 to be written to as part of the folding operation, the memory system 310 may read the aggregate data 355 from the volatile memory device 315 corresponding to the pageline 1 and perform a second set of programming operations to write the aggregate data 355 to the pageline 1 as part of a second stage of the write operation. That is, the memory system 310 may access a respective aggregate data 355 at a first time (e.g., after accumulating the aggregate data 355 at the volatile memory device 315) and at a second time (e.g., after completing the first stages for each pageline of the block 340). In some examples, accessing data via the volatile memory device 315 (e.g., a DRAM device) may reduce a latency of performing the folding operation at the memory system 310, for example, due to a latency associated with accessing the volatile memory device 315 being less than a latency associated with accessing non-volatile memory of the memory system 310.

Additionally, the memory system 310 may use the volatile memory device 315 in updating L2P mappings 360 associated with the transferred data. For example, because the memory system 310 moves the data to new physical addresses as part of the folding operation, the memory system 310 may update one or more L2P mapping tables to indicate the updated physical addresses of the data. Due to the faster speeds associated with the volatile memory device 320, the memory system 310 may use the volatile memory device 320 in updating L2P mappings 360 in accordance with the data being transferred to the non-volatile memory device 335. However, the storage capacity of the volatile memory device 320 (e.g., the portion of the volatile memory device allocated to support data transfer operations) may similarly be limited such that the volatile memory device 320 is unable to store updated L2P mappings 360 for use in updating corresponding entries of an L2P mapping table. For example, 2 megabytes (MB) of L2P information may be updated by the volatile memory device 320 in association with transferring 1024 MB to a QLC block, which may exceed the storage capacity of the volatile memory device 320. Accordingly, to support updating L2P mapping tables in accordance with folding operations, the memory system 310 may temporarily store the L2P mappings 360 to another device and subsequently retrieve the L2P mappings 360 when updating entries of one or more L2P mapping tables.

The memory system 310 use the volatile memory device 315 to temporarily store the L2P mappings 360. For instance, the memory system 310 may transmit one or more updated L2P mappings corresponding to a pageline of the block 340 upon the memory system 310 completing the write operation stages on the pageline. For example, after completing the second stage of the write operation associated with the pageline 1, the memory system 310 may begin to update, at the volatile memory device 320, L2P mappings 360 corresponding to the data written to the pageline 1 to indicate the new physical addresses of the data. The memory system 310 may transmit, to the host system 305, the updated L2P mappings 360 corresponding to the pageline 1 for storage at the volatile memory device 315 (e.g., prior to or in conjunction with performing a second stage of a write operation for another pageline). In some examples, the memory system 310 may update and transmit one or more of the L2P mappings 360 in respective chunks in accordance with the storage capacity of the volatile memory device 320.

The host system 305 may accumulate L2P mappings 360 at the volatile memory device 315 for each pageline of the block 340 to which data is transferred. That is, the memory system 310 may update and transmit L2P mappings 360 to the volatile memory device 315 that indicate the updated physical addresses of the data transferred to the non-volatile memory device 335. The host system 35 may transmit L2P data 365 that includes the L2P mappings 360 (e.g., in respective chunks according to the storage capacity of the volatile memory device 320) to the memory system 310 after the data has been successfully folded to the non-volatile memory device 335 (e.g., in response to read commands sent by the memory system 310). The memory system 310 may update entries of one or more L2P mapping tables using the L2P data 365. For example, the memory system 310 may transfer a portion of an L2P mapping table to the volatile memory device 320 from non-volatile memory, update one or more entries of the L2P mapping table in accordance with one or more L2P mappings 360 retrieved from the volatile memory device 315, and transfer updated portion of the L2P mapping table back to the non-volatile memory. The memory system 310 may continue to update entries of L2P mapping table(s) in this way until the updates to the physical addresses of the transferred data have been completed and captured.

FIG. 4 illustrates an example of a flowchart 400 that supports memory cell folding operations using host system memory in accordance with examples as disclosed herein. Aspects of the flowchart 400 may be implemented by one or more aspects of the system 300, the system 200 and the system 100 as described respectively with reference to FIGS. 3, 2, and 1. For example, the flowchart 400 may be implemented by a memory system utilizing volatile memory of a host system to support a folding operation, such as a memory system 310, 210, or 110 as described with reference to FIGS. 3, 2, and 1.

In the following description of the flowchart 400, the operations may be performed in a different order than the order shown. Specific operations also may be left out of the flowchart 400, or other operations may be added to the flowchart 400. Further, although some operations or signaling may be shown to occur at different times for discussion purposes, these operations may actually occur at the same time.

Aspects of the flowchart 400 may be implemented by a controller, among other components. Additionally or alternatively, aspects of the flowchart 400 may be implemented as instructions stored in memory (e.g., firmware stored in a memory coupled with the memory system). For example, the instructions, when executed by a controller (e.g., a memory system controller), may cause the controller to perform the operations of the flowchart 400.

At 405, a folding operation to transfer data from a first non-volatile memory device of the memory system to a second non-volatile memory device of the memory system may be initiated. The first non-volatile memory device may include memory cells each configured to store a first quantity of bits (e.g., an SLC memory array, a TLC memory array), and the second non-volatile memory device may memory cells each configured to store a second quantity of bits that is greater than the first quantity of bits (e.g., a QLC memory array, a set of memory cells for storing more than four bits of information). In some cases, the first non-volatile memory device and the second non-volatile memory device may be part of a same non-volatile memory device (e.g., be different portions of a same non-volatile memory device).

At 410, a source block of the first non-volatile memory device (e.g., a source SLC block, a source block 330) may be selected for folding. For example, the memory system may identify a source block of the first non-volatile memory device including valid data that is to be transferred to the second non-volatile memory device and may select the source block for scanning.

At 415, the selected source block may be scanned for valid data. For example, the memory system may scan the selected source block for valid data and may transfer the valid data to a first volatile memory device of the memory system (e.g., volatile memory device 320). In some examples, the memory system may scan the selected source block for valid translation units to transfer to the first volatile memory device. For example, in some cases, a virtual block may include virtual pages. For instance, a page (e.g., a page 175) may include at least a first quantity of storage (e.g., 16 kilobytes (kB), among other quantities of storage). A virtual page may correspond to a data granularity associated with the type of memory system (e.g., a granularity at which data may be written, read, or both). For example, the virtual page may correspond to a second quantity of storage (e.g., 4 kB for UFS, 512 B for eMMC) from which data may be read or to which data may be written. In some examples, the virtual pages may be referred to as translation units (e.g., data units) and may represent a minimal amount of data pointed to by entries of a flash translation layer (FTL) table. In some cases, logical translation units (e.g., logical addresses of the translation units) may be used to indicate data at a logical level (e.g., at a host and controller level), and the translation units may be the physical locations at which the logical data is stored.

In some examples, to scan the selected source block, the memory system may perform one or more L2P translations. For example, the memory system may use stored L2P information (e.g., page validity information) to determine which translation units of the selected source block are valid (e.g., instead of empty or invalid).

At 420, it may be determined whether a threshold quantity of valid data (e.g., valid translation units) has been transferred to the first volatile memory device. In an example, the memory system may determine whether four valid translation units per plane of the first non-volatile memory device have been transferred to the first volatile memory device, which may correspond to a storage capacity of the first volatile memory device (e.g., of a portion of the first volatile memory device allocated for performing a folding operation). That is, the first volatile memory device may accumulate first data (e.g., multiple translation units) from the first non-volatile memory device until a quantity of the first data satisfies (e.g., equals, meets) the allocated storage capacity of the first volatile memory device.

If, at 420, the memory system determines that the threshold quantity of valid data has not been transferred to the first volatile memory device (e.g., the size of the first data is less than the allocated storage capacity of the first volatile memory device), the flowchart 400 may proceed to 425. At 425, it may be determined whether the selected source block has been fully scanned for valid data. For example, the memory system may determine whether the selected source block is fully scanned based on determining that the first volatile memory device has not accumulated data which satisfies the capacity of the first volatile memory device. If the memory system determines that the source block has not been fully scanned, the memory system may return to 415 and continue to scan the source block for additional valid data to transfer to the first volatile memory device. Alternatively, if the memory system determines that the source block has been fully scanned, the memory system may return to 410 and select a new source block to scan for additional valid data to transfer to the first volatile memory device.

If, at 420, the memory system determines that the threshold quantity of valid data has been transferred to the first volatile memory device (e.g., the size of the first data equals the allocated storage capacity of the first volatile memory device), the flowchart 400 may proceed to 430. At 430, the first data accumulated at the first volatile memory device may be transmitted to a second volatile memory device of a host system (e.g., a volatile memory device 315). For example, upon determining that the first data has a size satisfying the allocated storage capacity of the first volatile memory device, the memory system may transmit the first data to the second volatile memory device for temporary storage. In some examples, such data may be an example of a data chunk 350 as described with reference to FIG. 3.

At 435, it may be determined whether a threshold quantity of data has been accumulated at (e.g., transferred to) the host system. For example, the memory system may determine whether the second volatile memory device has accumulated data (e.g., second data including the first data and other data that may have been previously accumulated at the second volatile memory device) which has a size that satisfies a threshold value. In some cases, the threshold value may correspond to a quantity of data that may be stored by a pageline of a block of the second non-volatile memory device (e.g., a pageline of a QLC block).

If, at 435, the memory system determines that the second volatile memory device has not accumulated data satisfying the threshold value (e.g., the size of the second data is less than the threshold value), the memory system may return to 415 and continue to scan a selected source block for valid data. That is, the memory system may continue to accumulate data (e.g., third data) at the first volatile memory device and transfer the accumulated data to the second volatile memory device (e.g., in data chunks corresponding to the allocated storage capacity of the first volatile memory device) until the second volatile memory device has accumulated data satisfying the threshold value (e.g., until the size of the second data satisfies the threshold value).

Alternatively, if, at 435, the memory system determines that the second volatile memory device has accumulated data whose size satisfies the threshold value (e.g., a QLC pageline), the flowchart 400 may proceed to 440.

At 440, the second data may be retrieved from the second volatile memory device and written to the second non-volatile memory device. For instance, based on the second data satisfying the threshold value, the memory system may receive the second data accumulated at the second volatile memory device (e.g., read the second data from the second volatile memory device, trigger one or more data transfers from the second volatile memory device to the first volatile memory device). For example, the host system may transmit the second data to the memory system in data chunks in accordance with the allocated storage capacity of the first volatile memory device. The memory system may, upon receiving a data chunk, write the data chunk to the second non-volatile memory device as part of a stage of a write operation. Additionally, the memory system may delete the data chunk from the first volatile memory device prior to receiving a subsequent data chunk (e.g., to facilitate receiving the subsequent data chunk, for example, by freeing up space at the first volatile memory device).

At 445, it may be evaluated whether the stages of a write operation for a current pageline have been completed based on writing the second data to the second non-volatile memory device at 440. For example, the second data accumulated at the second volatile memory device of the host system and transferred to the memory system may be written to a pageline of the second non-volatile memory device. The memory system may determine whether the stages of the write operation to write the second data to the pageline have been completed. For example, in a two-stage write operation, the second data may be written to the pageline in response to a second stage of the write operation (e.g., a second time that the data is written to the pageline. Thus, the memory system may determine whether the second data has been successfully written to the pageline or whether writing the second data to the pageline is at an intermediate stage.

If, at 445, the memory system determines that the stages of the write operation for the current pageline are yet to be completed (e.g., the second stage has not yet been performed, writing the second data to the pageline at 440 corresponded to the first stage of the write operation), the flowchart 400 may proceed to 450. At 450, a folding step for the current pageline may end. That is, operations associated with transferring the second data to the current pageline may be temporarily paused. In some examples, the memory system may return to 405 to accumulate additional data at the second volatile memory device to transfer to another pageline of the second non-volatile memory device. For example, if additional data is to be transferred to additional pagelines of the second non-volatile memory device that is yet to be accumulated and transmitted to the second volatile memory device, the memory system may repeat step 405 through step 450 for each additional pageline of the second non-volatile memory device to which data is to be transferred. That is, the memory system may accumulate and store additional data at the second volatile memory device of the host system such that a respective first stage of write operations to write data to the pagelines of the second non-volatile memory device may be performed.

In some examples, at 450, the memory system may determine that the current pageline is a last pageline to which data is to be transferred. That is, the memory system may determine that the first stage has been performed on the last pageline and that the second stages of the write operations may begin to be performed. Because the data has already been transferred to and accumulated at the second volatile memory device, the memory system may not need to re-accumulate data at the second volatile memory device to perform the second stage of the write operations. That is, second volatile memory device may continue to store the data transferred to it from the first volatile memory device such that the data may continually (e.g., repeatedly) be read by the memory system to support multi-stage write operations. Accordingly, after performing a first stage of a write operation for the last pageline, the memory system may receive, from the second volatile memory device, accumulated data corresponding to a first pageline (e.g., the second data in respective chunks) and may perform a second stage of a write operation to the write the accumulated data to the first pageline. Here, at 445, the memory system may determine that the stages of the write operations have been completed for the current pageline (e.g., the first pageline, a subsequent pageline for which a second stage of a write operation has been performed), and the flowchart 400 may proceed to 455.

At 455, L2P mappings associated with the current pageline (e.g., the second data) may be updated. For example, based on performing the second stage of the write operation for the current pageline (e.g., the first pageline), the memory system may update a set of L2P mappings (e.g., at the first volatile memory device) corresponding to the data written to the current pageline to indicate the updated physical addresses of the data (e.g., physical addresses of memory cells included in the current pageline).

At 460, it may be determined whether folding for a block of data to the second non-volatile memory device has been completed (e.g., transferred from one or more non-volatile memory devices of the memory system to the second non-volatile memory device). That is, the memory system may determine whether respective second stages of respective write operations for each pageline of the second non-volatile memory device has been performed.

If, at 460, the memory system determines that the folding has not been completed, the flowchart 400 may proceed to 465. At 465, it may be determined whether a size of the L2P mapping updates (e.g., a quantity of storage space occupied by the L2P mapping updates) satisfies a threshold. For example, the memory system may determine whether a portion of the first volatile memory device allocated for storing L2P mappings is full (e.g., whether a storage capacity of the portion of the first volatile memory device has been reached due to updating the L2P mappings). In some examples, the portion of the first volatile memory device allocated for storing L2P mappings may be the same as the portion of the first volatile memory device allocated for performing a folding operation. In some cases, the memory system may determine that the L2P mapping updates in the first volatile memory device fail to satisfy the threshold and may continue to store the L2P mappings at the first volatile memory device.

However, if, at 465, the memory system determines that the size of the L2P mapping updates satisfies the threshold, the flowchart 400 may proceed to 470. At 470, the memory system may transfer the updated L2P mappings from the first volatile memory device to the second volatile memory device. That is, the memory system may transmit the updated L2P mappings to the second volatile memory device for temporary storage based on the storage capacity of the portion of the first volatile memory device allocated for storing L2P mappings being reached. In some examples, the memory system may update a subset of the L2P mappings corresponding the current pageline may cause the threshold to be satisfied, and the memory system may transmit the updated L2P mappings to the second volatile memory device in respective chunks.

In some cases, the second volatile memory device may accumulate L2P mappings for each of the pageline of the second non-volatile memory device to which data is transferred. That is, as the respective second stages of respective write operations are performed for each of the pagelines, the memory system may update corresponding L2P mappings and transmit the updated L2P mappings to the second volatile memory device in accordance with the allocated storage capacity of the first volatile memory device.

If, at 460, the memory system determines that folding for the block of the data has been completed, the flowchart 400 may proceed to 475. At 475, entries of one or more L2P mapping tables may be updated in accordance with the updated L2P mappings. For example, the memory system may update entries of a L2P mapping table upon determining that the data has been successfully transferred from the first non-volatile memory device to the second non-volatile memory device. That is, the memory system may receive the L2P mappings accumulated at the second volatile memory device (e.g., in respective chunks) after folding to the second non-volatile memory device has been completed and may use the L2P mappings to update corresponding entries of the L2P mapping table to indicate the updated physical addresses of the data transferred to the second non-volatile memory device. For example, the entries of the L2P mapping table may map logical addresses of the transferred data to physical addresses of the memory system. The entries may be updated to reflect the updated physical addresses of the second non-volatile memory device to which the data was transferred.

FIG. 5 shows a block diagram 500 of a memory system 520 that supports memory cell folding operations using host system memory in accordance with examples as disclosed herein. The memory system 520 may be an example of aspects of a memory system as described with reference to FIGS. 1 through 4. The memory system 520, or various components thereof, may be an example of means for performing various aspects of memory cell folding operations using host system memory as described herein. For example, the memory system 520 may include a data transfer component 525, a data transmission component 530, a data reception component 535, a write component 540, a block scanning component 545, a L2P mapping component 550, a L2P transmission component 555, a data deletion component 560, an allocation component 565, a block identification component 570, a L2P reception component 575, or any combination thereof. Each of these components may communicate, directly or indirectly, with one another (e.g., via one or more buses).

The data transfer component 525 may be configured as or otherwise support a means for transferring first data from a first non-volatile memory device of a memory system to a first volatile memory device of the memory system. The data transmission component 530 may be configured as or otherwise support a means for transmitting the first data from the first volatile memory device to a second volatile memory device of a host system based at least in part on a storage capacity of the first volatile memory device. The data reception component 535 may be configured as or otherwise support a means for receiving, from the second volatile memory device, second data including the first data based at least in part on a size of the second data satisfying a threshold. The write component 540 may be configured as or otherwise support a means for writing the second data to a second non-volatile memory device of the memory system that includes a set of multiple-level memory cells for storing four or more bits of information.

In some examples, the block scanning component 545 may be configured as or otherwise support a means for scanning one or more source blocks of the first non-volatile memory device for valid data, where the first data includes a first portion of the valid data stored at the one or more source blocks. In some examples, the data transfer component 525 may be configured as or otherwise support a means for transferring, at a first time before receiving the second data, third data from the first non-volatile memory device to the first volatile memory device based at least in part on the size of the second data failing to satisfy the threshold at the first time, the third data corresponding to a second portion of the valid data stored at the one or more source blocks. In some examples, the data transmission component 530 may be configured as or otherwise support a means for transmitting, at a second time, the third data from the first volatile memory device to the second volatile memory device, where the second data includes the first data and the third data and the size of the second data satisfies the threshold at the second time based at least in part on the transmission of the third data.

In some examples, to support writing the second data to the second non-volatile memory device, the write component 540 may be configured as or otherwise support a means for performing a first stage of a write operation on a subset of the set of multiple-level memory cells. In some examples, to support writing the second data to the second non-volatile memory device, write component 540 may be configured as or otherwise support a means for performing a second stage of the write operation on the subset of the set of multiple-level memory cells after the first stage, where the second data is written to the second non-volatile memory device based at least in part on the second stage.

In some examples, to support receiving the second data, the data reception component 535 may be configured as or otherwise support a means for receiving the second data from the second volatile memory device a first time, where the first stage is performed using the second data received at the first time. In some examples, to support receiving the second data, the data reception component 535 may be configured as or otherwise support a means for receiving the second data from the second volatile memory device a second time, where the second stage is performed using the second data received at the second time.

In some examples, the L2P mapping component 550 may be configured as or otherwise support a means for updating, at the first volatile memory device based at least in part on writing the second data, a first subset of L2P mappings associated with the second data in accordance with the second data being written to the second non-volatile memory device. In some examples, the L2P transmission component 555 may be configured as or otherwise support a means for transmitting the first subset of L2P mappings from the first volatile memory device to the second volatile memory device based at least in part on the storage capacity of the first volatile memory device.

In some examples, the L2P mapping component 550 may be configured as or otherwise support a means for updating, at the first volatile memory device and after transmitting the first subset of L2P mappings, a second subset of L2P mappings associated with the second data in accordance with the second data being written to the second non-volatile memory device. In some examples, the L2P transmission component 555 may be configured as or otherwise support a means for transmitting the second subset of L2P mappings from the first volatile memory device to the second volatile memory device based at least in part on the storage capacity of the first volatile memory device.

In some examples, the block identification component 570 may be configured as or otherwise support a means for determining whether a block of data has been transferred from one or more non-volatile memory devices of the memory system to the second non-volatile memory device. In some examples, the L2P reception component 575 may be configured as or otherwise support a means for receiving, from the second volatile memory device, a set of L2P mappings including the first subset of L2P mappings based at least in part on the block of data having been written to the second non-volatile memory device. In some examples, the L2P mapping component 550 may be configured as or otherwise support a means for updating, based at least in part on the set of L2P mappings, a set of entries of a L2P mapping table that map logical addresses of the memory system to physical addresses of the memory system.

In some examples, to support receiving the second data, the data reception component 535 may be configured as or otherwise support a means for receiving the second data at the first volatile memory device in respective data chunks having sizes corresponding to the storage capacity of the first volatile memory device. In some examples, the data deletion component 560 may be configured as or otherwise support a means for deleting a data chunk from the first volatile memory device after writing the data chunk to the second non-volatile memory device and before receiving a next data chunk.

In some examples, the allocation component 565 may be configured as or otherwise support a means for transmitting, to the host system, a request for the host system to allocate a portion of the second volatile memory device to the memory system for storage. In some examples, the allocation component 565 may be configured as or otherwise support a means for receiving, from the host system, an indication that the portion of the second volatile memory device has been allocated in response to the request, where the first data is transmitted to the second volatile memory device based at least in part on the indication.

In some examples, a size of the first data equals a size of the storage capacity of the first volatile memory device allocated for transfer operations associated with writing data to multiple-level memory cells for storing four or more bits of information. In some examples, the first data is transmitted to the host system based at least in part on equaling the storage capacity of the first volatile memory device.

In some examples, the threshold corresponds to a quantity of data stored by a pageline of the second non-volatile memory device.

In some examples, first non-volatile memory device and the second non-volatile memory device are the same non-volatile memory device.

FIG. 6 shows a flowchart illustrating a method 600 that supports memory cell folding operations using host system memory in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include transferring first data from a first non-volatile memory device of a memory system to a first volatile memory device of the memory system. The operations of 605 may be performed in accordance with examples as disclosed herein. In some examples, aspects of the operations of 605 may be performed by a data transfer component 525 as described with reference to FIG. 5.

At 610, the method may include transmitting the first data from the first volatile memory device to a second volatile memory device of a host system based at least in part on a storage capacity of the first volatile memory device. The operations of 610 may be performed in accordance with examples as disclosed herein. In some examples, aspects of the operations of 610 may be performed by a data transmission component 530 as described with reference to FIG. 5.

At 615, the method may include receiving, from the second volatile memory device, second data including the first data based at least in part on a size of the second data satisfying a threshold. The operations of 615 may be performed in accordance with examples as disclosed herein. In some examples, aspects of the operations of 615 may be performed by a data reception component 535 as described with reference to FIG. 5.

At 620, the method may include writing the second data to a second non-volatile memory device of the memory system that includes a set of multiple-level memory cells for storing four or more bits of information. The operations of 620 may be performed in accordance with examples as disclosed herein. In some examples, aspects of the operations of 620 may be performed by a write component 540 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for transferring first data from a first non-volatile memory device of a memory system to a first volatile memory device of the memory system; transmitting the first data from the first volatile memory device to a second volatile memory device of a host system based at least in part on a storage capacity of the first volatile memory device; receiving, from the second volatile memory device, second data including the first data based at least in part on a size of the second data satisfying a threshold; and writing the second data to a second non-volatile memory device of the memory system that includes a set of multiple-level memory cells for storing four or more bits of information.

Aspect 2: The method, apparatus, or non-transitory computer-readable medium of aspect 1, further including operations, features, circuitry, logic, means, or instructions, or any combination thereof for scanning one or more source blocks of the first non-volatile memory device for valid data, where the first data includes a first portion of the valid data stored at the one or more source blocks; transferring, at a first time before receiving the second data, third data from the first non-volatile memory device to the first volatile memory device based at least in part on the size of the second data failing to satisfy the threshold at the first time, the third data corresponding to a second portion of the valid data stored at the one or more source blocks; and transmitting, at a second time, the third data from the first volatile memory device to the second volatile memory device, where the second data includes the first data and the third data and the size of the second data satisfies the threshold at the second time based at least in part on the transmission of the third data.

Aspect 3: The method, apparatus, or non-transitory computer-readable medium of any of aspects 1 through 2, where writing the second data to the second non-volatile memory device includes operations, features, circuitry, logic, means, or instructions, or any combination thereof for performing a first stage of a write operation on a subset of the set of multiple-level memory cells and performing a second stage of the write operation on the subset of the set of multiple-level memory cells after the first stage, where the second data is written to the second non-volatile memory device based at least in part on the second stage.

Aspect 4: The method, apparatus, or non-transitory computer-readable medium of aspect 3, where receiving the second data includes operations, features, circuitry, logic, means, or instructions, or any combination thereof for receiving the second data from the second volatile memory device a first time, where the first stage is performed using the second data received at the first time and receiving the second data from the second volatile memory device a second time, where the second stage is performed using the second data received at the second time.

Aspect 5: The method, apparatus, or non-transitory computer-readable medium of any of aspects 1 through 4, further including operations, features, circuitry, logic, means, or instructions, or any combination thereof for updating, at the first volatile memory device based at least in part on writing the second data, a first subset of L2P mappings associated with the second data in accordance with the second data being written to the second non-volatile memory device and transmitting the first subset of L2P mappings from the first volatile memory device to the second volatile memory device based at least in part on the storage capacity of the first volatile memory device.

Aspect 6: The method, apparatus, or non-transitory computer-readable medium of aspect 5, further including operations, features, circuitry, logic, means, or instructions, or any combination thereof for updating, at the first volatile memory device and after transmitting the first subset of L2P mappings, a second subset of L2P mappings associated with the second data in accordance with the second data being written to the second non-volatile memory device and transmitting the second subset of L2P mappings from the first volatile memory device to the second volatile memory device based at least in part on the storage capacity of the first volatile memory device.

Aspect 7: The method, apparatus, or non-transitory computer-readable medium of any of aspects 5 through 6, further including operations, features, circuitry, logic, means, or instructions, or any combination thereof for determining whether a block of data has been transferred from one or more non-volatile memory devices of the memory system to the second non-volatile memory device; receiving, from the second volatile memory device, a set of L2P mappings including the first subset of L2P mappings based at least in part on the block of data having been written to the second non-volatile memory device; and updating, based at least in part on the set of L2P mappings, a set of entries of a L2P mapping table that map logical addresses of the memory system to physical addresses of the memory system.

Aspect 8: The method, apparatus, or non-transitory computer-readable medium of any of aspects 1 through 7, where receiving the second data includes operations, features, circuitry, logic, means, or instructions, or any combination thereof for receiving the second data at the first volatile memory device in respective data chunks having sizes corresponding to the storage capacity of the first volatile memory device, the method apparatus, or non-transitory computer-readable medium further including operations, features, circuitry, logic, means, or instructions, or any combination thereof for deleting a data chunk from the first volatile memory device after writing the data chunk to the second non-volatile memory device and before receiving a next data chunk.

Aspect 9: The method, apparatus, or non-transitory computer-readable medium of any of aspects 1 through 8, further including operations, features, circuitry, logic, means, or instructions, or any combination thereof for transmitting, to the host system, a request for the host system to allocate a portion of the second volatile memory device to the memory system for storage and receiving, from the host system, an indication that the portion of the second volatile memory device has been allocated in response to the request, where the first data is transmitted to the second volatile memory device based at least in part on the indication.

Aspect 10: The method, apparatus, or non-transitory computer-readable medium of any of aspects 1 through 9, where a size of the first data equals a size of the storage capacity of the first volatile memory device allocated for transfer operations associated with writing data to multiple-level memory cells for storing four or more bits of information and the first data is transmitted to the host system based at least in part on equaling the storage capacity of the first volatile memory device.

Aspect 11: The method, apparatus, or non-transitory computer-readable medium of any of aspects 1 through 10, where the threshold corresponds to a quantity of data stored by a pageline of the second non-volatile memory device.

Aspect 12: The method, apparatus, or non-transitory computer-readable medium of any of aspects 1 through 11, where first non-volatile memory device and the second non-volatile memory device are the same non-volatile memory device.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” refers to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, the described functions can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
a first non-volatile memory device;
a second non-volatile memory device;
a first volatile memory device; and
a controller coupled with the first non-volatile memory device and the first volatile memory device, wherein the controller is configured to cause the apparatus to:
transfer first data from the first non-volatile memory device to the first volatile memory device;
transmit the first data from the first volatile memory device to a second volatile memory device of a host system based at least in part on a storage capacity of the first volatile memory device;
receive, from the second volatile memory device, second data comprising the first data based at least in part on a size of the second data satisfying a threshold; and
write the second data to the second non-volatile memory device that comprises a set of multiple-level memory cells for storing four or more bits of information.

2. The apparatus of claim 1, wherein the controller is further configured to cause the apparatus to:
scan one or more source blocks of the first non-volatile memory device for valid data, wherein the first data comprises a first portion of the valid data stored at the one or more source blocks;
transfer, at a first time before receiving the second data, third data from the first non-volatile memory device to the first volatile memory device based at least in part on the size of the second data failing to satisfy the threshold at the first time, the third data corresponding to a second portion of the valid data stored at the one or more source blocks; and
transmit, at a second time, the third data from the first volatile memory device to the second volatile memory device, wherein the second data comprises the first data and the third data and the size of the second data satisfies the threshold at the second time based at least in part on the transmission of the third data.

3. The apparatus of claim 1, wherein, to write the second data to the second non-volatile memory device, the controller is configured to cause the apparatus to:
perform a first stage of a write operation on a subset of the set of multiple-level memory cells; and
perform a second stage of the write operation on the subset of the set of multiple-level memory cells after the first stage, wherein the second data is written to the second non-volatile memory device based at least in part on the second stage.

4. The apparatus of claim 3, wherein, to receive the second data, the controller is configured to cause the apparatus to:
receive the second data from the second volatile memory device a first time, wherein the first stage is performed using the second data received at the first time; and
receive the second data from the second volatile memory device a second time, wherein the second stage is performed using the second data received at the second time.

5. The apparatus of claim 1, wherein the controller is further configured to cause the apparatus to:
update, at the first volatile memory device based at least in part on writing the second data, a first subset of logical-to-physical mappings associated with the second data in accordance with the second data being written to the second non-volatile memory device; and
transmit the first subset of logical-to-physical mappings from the first volatile memory device to the second volatile memory device based at least in part on the storage capacity of the first volatile memory device.

6. The apparatus of claim 5, wherein the controller is further configured to cause the apparatus to:
update, at the first volatile memory device and after transmitting the first subset of logical-to-physical mappings, a second subset of logical-to-physical mappings associated with the second data in accordance with the second data being written to the second non-volatile memory device; and
transmit the second subset of logical-to-physical mappings from the first volatile memory device to the second volatile memory device based at least in part on the storage capacity of the first volatile memory device.

7. The apparatus of claim 5, wherein the controller is further configured to cause the apparatus to:
determine whether a block of data has been transferred from one or more non-volatile memory devices of the apparatus to the second non-volatile memory device;
receive, from the second volatile memory device, a set of logical-to-physical mappings comprising the first subset of logical-to-physical mappings based at least in part on the block of data having been written to the second non-volatile memory device; and
update, based at least in part on the set of logical-to-physical mappings, a set of entries of a logical-to-physical mapping table that map logical addresses of the apparatus to physical addresses of the apparatus.

8. The apparatus of claim 1, wherein, to receive the second data, the controller is configured to cause the apparatus to:
receive the second data at the first volatile memory device in respective data chunks having sizes corresponding to the storage capacity of the first volatile memory device, the controller further configured to cause the apparatus to:
delete a data chunk from the first volatile memory device after writing the data chunk to the second non-volatile memory device and before receiving a next data chunk.

9. The apparatus of claim 1, wherein the controller is further configured to cause the apparatus to:
transmit, to the host system, a request for the host system to allocate a portion of the second volatile memory device to the apparatus for storage; and
receive, from the host system, an indication that the portion of the second volatile memory device has been allocated in response to the request, wherein the first data is transmitted to the second volatile memory device based at least in part on the indication.

10. The apparatus of claim 1, wherein:
a size of the first data equals a size of the storage capacity of the first volatile memory device allocated for transfer operations associated with writing data to multiple-level memory cells for storing four or more bits of information, and
the first data is transmitted to the host system based at least in part on equaling the storage capacity of the first volatile memory device.

11. The apparatus of claim 1, wherein the threshold corresponds to a quantity of data stored by a pageline of the second non-volatile memory device.

12. The apparatus of claim 1, wherein the first non-volatile memory device and the second non-volatile memory device are the same non-volatile memory device.

13. A non-transitory computer-readable medium storing code comprising instructions which, when executed by a processor of an electronic device, cause the electronic device to:
transfer first data from a first non-volatile memory device of a memory system to a first volatile memory device of the memory system;
transmit the first data from the first volatile memory device to a second volatile memory device of a host system based at least in part on a storage capacity of the first volatile memory device;
receive, from the second volatile memory device, second data comprising the first data based at least in part on a size of the second data satisfying a threshold; and
write the second data to a second non-volatile memory device of the memory system that comprises a set of multiple-level memory cells for storing four or more bits of information.

14. The non-transitory computer-readable medium of claim 13, wherein the instructions, when executed by the processor of the electronic device, further cause the electronic device to:
scan one or more source blocks of the first non-volatile memory device for valid data, wherein the first data comprises a first portion of the valid data stored at the one or more source blocks;
transfer, at a first time before receiving the second data, third data from the first non-volatile memory device to the first volatile memory device based at least in part on the size of the second data failing to satisfy the threshold at the first time, the third data corresponding to a second portion of the valid data stored at the one or more source blocks; and
transmit, at a second time, the third data from the first volatile memory device to the second volatile memory device, wherein the second data comprises the first data and the third data and the size of the second data satisfies the threshold at the second time based at least in part on the transmission of the third data.

15. The non-transitory computer-readable medium of claim 13, wherein the instructions to write the second data to the second non-volatile memory device, when executed by the processor of the electronic device, cause the electronic device to:
perform a first stage of a write operation on a subset of the set of multiple-level memory cells; and
perform a second stage of the write operation on the subset of the set of multiple-level memory cells after the first stage, wherein the second data is written to the second non-volatile memory device based at least in part on the second stage.

16. The non-transitory computer-readable medium of claim 15, wherein the instructions to receive the second data, when executed by the processor of the electronic device, cause the electronic device to:
receive the second data from the second volatile memory device a first time, wherein the first stage is performed using the second data received at the first time; and
receive the second data from the second volatile memory device a second time, wherein the second stage is performed using the second data received at the second time.

17. The non-transitory computer-readable medium of claim 13, wherein the instructions, when executed by the processor of the electronic device, further cause the electronic device to:
update, at the first volatile memory device based at least in part on writing the second data, a first subset of logical-to-physical mappings associated with the second data in accordance with the second data being written to the second non-volatile memory device; and
transmit the first subset of logical-to-physical mappings from the first volatile memory device to the second volatile memory device based at least in part on the storage capacity of the first volatile memory device.

18. The non-transitory computer-readable medium of claim 17, wherein the instructions, when executed by the processor of the electronic device, further cause the electronic device to:
update, at the first volatile memory device and after transmitting the first subset of logical-to-physical mappings, a second subset of logical-to-physical mappings associated with the second data in accordance with the second data being written to the second non-volatile memory device; and
transmit the second subset of logical-to-physical mappings from the first volatile memory device to the second volatile memory device based at least in part on the storage capacity of the first volatile memory device.

19. The non-transitory computer-readable medium of claim 17, wherein the instructions, when executed by the processor of the electronic device, further cause the electronic device to:
determine whether a block of data has been transferred from one or more non-volatile memory devices of the memory system to the second non-volatile memory device;
receive, from the second volatile memory device, a set of logical-to-physical mappings comprising the first subset of logical-to-physical mappings based at least in part on the block of data having been written to the second non-volatile memory device; and
update, based at least in part on the set of logical-to-physical mappings, a set of entries of a logical-to-physical mapping table that map logical addresses of the memory system to physical addresses of the memory system.

20. A method, comprising:
transferring first data from a first non-volatile memory device of a memory system to a first volatile memory device of the memory system;
transmitting the first data from the first volatile memory device to a second volatile memory device of a host system based at least in part on a storage capacity of the first volatile memory device;
receiving, from the second volatile memory device, second data comprising the first data based at least in part on a size of the second data satisfying a threshold; and
writing the second data to a second non-volatile memory device of the memory system that comprises a set of multiple-level memory cells for storing four or more bits of information.
